(19) United States
(12) Patent Application Publication
(10) Pub. No.: US 2016/0259896 A1
(43) Pub. Date: Sep. 8, 2016

(54) SEGMENTED TEMPORAL ANALYSIS MODEL USED IN FRAUD, WASTE, AND ABUSE DETECTION

(71) Applicant: Xerox Corporation, Norwalk, CT (US)

(72) Inventor: Ming Yang, Fairport, NY (US)

(21) Appl. No.: 14/640,570

(22) Filed: Mar. 6, 2015

(51) Int. Cl. G06F 19/00; G06Q 30/00

(52) U.S. Cl. CPC G06F 19/328; G06Q 30/0185

(57) ABSTRACT

Presented are a method, system, and apparatus for determining whether an electronically submitted medical claim has a high likelihood of being fraud, waste, and/or abuse in medical billing. A computing device receives the electronic medical claim containing a subject patient identifier identifying a subject patient. A plurality of subject patient characteristic datapoints are accessed with the subject patient identifier and the datapoints segmented. Event codes regarding each patient are accessed to generate one or more event sequences. The event sequences are grouped according to a particular event followed by one or more related events and analyzed to calculate a probability the related events following the particular event. The event sequences are analyzed again and a probability calculated of the particular event following the related events. Other steps may be utilized, and the submitted medical claim dishonored if it has a high likelihood of being fraud, waste, and/or abuse.

### TECHNICAL FIELD

The present invention is generally related to the field of detection of fraud, waste, and abuse in medical insurance claims. More specifically, the invention is directed towards a system, method, and apparatus utilizing a specialized computing device to analyze medical record history of a plurality of patients automatically in assessing for fraud, waste, and/or abuse in medical billing via utilization of a segmented temporal analysis analyzing event codes sequences of each patient stored in a computer database, such as a claims database or a medical record database. The present invention is useful for parties including, but not limited to, insurers, underwriters, claims administrators, doctors, other medical professionals, medical supply distributors, as well as anyone involved in the health insurance industry interested in automatically and efficiently reducing the amount of fraud, waste, and abuse presented in medical insurance claims. The simple volume of medical insurance claims presented in medical billing is too much for any one or group of individuals to process, and the volumes of data presented require the use of a specialized computing device to manage.

### BACKGROUND

Current spending by the private health insurance industry, Medicare, and Medicaid in the United States is more than one trillion U.S. dollars per year. Unfortunately, as with any large expenditure, the amounts of money at issue makes healthcare spending highly susceptible to fraud, waste, and abuse by unscrupulous individuals seeking to make easy money as well as careless individuals making no attempts to control spending. To better understand the risk of these, first consider the meaning of each. “Fraud” may be understood to be intentionally committing illegal activities by a medical provider or supplier to earn something of value without having to pay for it or earn it, such as obtaining kickbacks or submitting bills for services which were not performed. “Waste” includes spending on services that do not clearly provide better health care outcomes compared to less-expensive alternatives; inefficient practices; and costs incurred treating avoidable medical injuries; failing to coordinate care between medical professionals; overtreatment; administrative challenges; etc. “Abuse” occurs when a medical provider or supplier bends rules or does not follow good medical practices, resulting in unnecessary costs or improper payments, such as because of overuse of services or providing of unnecessary tests.

The sum of all types of fraud, waste, and abuse is a substantial drain on the public and private health insurance industries, leading to both higher insurance premiums and decreased quality of care for all customers.

Insurers, underwriters, claims administrators, and even doctors and other medical professionals who ethically bill, as well as all individuals involved with medical insurance claims are presented with the need to reduce these amounts on a day-to-day basis in real-time, considering volumes of insurance claims considered, and the corresponding amount of money at issue. Accordingly, a need exists for a system, method, and apparatus for detection of fraud, waste, and abuse in medical insurance claims.

### SUMMARY

The present invention is directed towards a system, method, and apparatus utilizing a specialized computing device to analyze electronic medical record history of a plurality of patients automatically in determining whether an electronically submitted medical claim has a high likelihood of being fraud, waste, and/or abuse in medical billing. A segmented temporal analysis is utilized, analyzing event codes of each patient. A variety of analysis steps are performed by the specialized computing device as discussed further herein, and a dishonor message may be issued if it is determined the electronically submitted medical claim has a high likelihood of being fraud, waste, and/or abuse.

In an embodiment of the invention, the invention comprises a system, method, and apparatus utilizing a specialized computing device to determine whether an electronically submitted medical claim submitted for payment has a high likelihood of being fraud, waste, and/or abuse in medical billing. A segmented temporal analysis is utilized of electronic medical record history of a plurality of patients. Beginning execution, the specialized computing device receives the electronically submitted medical claim. The electronically submitted medical claim contains a subject patient identifier identifying a subject patient in connection with the electronically submitted medical claim was submitted. The specialized computing device accesses a plurality of subject patient characteristic datapoints using the subject patient identifier. The specialized computing device then accesses a computer database, the computer database storing a plurality of patient characteristic datapoints regarding individuals characteristics of the plurality of patients (including, but not limited to, age of patient, gender of patient, and location of patient (the location maintained according to town, municipality, zip code, state, or country)). Each patient characteristic datapoint is associated with a patient identifier unique to each patient of the plurality of patients. In various embodiments, the computer database may be a claims database or an electronic medical record database. The subject patient identifier and/or patient identifier may be confidential identification numbers (such as, by means of non-limiting example, nine-digit hyphenated numbers, similar to social security numbers).

The plurality of patient characteristic datapoints are segmented into segmented patient groups according to each individual characteristic. The specialized computing device then accesses the computer database, the computer database storing event codes regarding each patient in all segmented patient groups to which the subject patient belongs, and analyzes the accessed event codes to generate one or more event sequences. The specialized computing device, when generating the one or more event sequences, may analyze the accessed event codes using one or more of the following: a neighboring-event sequence-seeking method, a starting-point fixed event sequence-seeking method, and a complete sequence seeking method.

The specialized computing device groups the one or more event sequences according to a particular event followed by one or more related events, followed by analysis by the specialized computing device of the one or more event sequences. A probability is calculated of the one or more related events following the particular event in the one or more event sequences. Finally, the specialized computing device analyzes the event sequences and calculates a probability of the particular event following the one or more related events in the one or more event sequences. In a further embodiment, after calculating the probability of the particular event following the one or more related events, the specialized computing device classifies the one or more event sequences as bi-directional, one directional, or rare, the classification based upon a calculated directional ratio. In various embodiments, based upon the classification of event sequences as bi-directional, one directional, or rare (or exclusively based upon event sequences classified as one directional), the specialized computing device may determine whether each classified event in the event sequences is a normal event temporal pattern or an abnormal event temporal pattern. The specialized computing device may then proceed based upon classified events in the event sequence classified as normal event temporal patterns and abnormal event temporal patterns to determine whether the electronically submitted medical claim has a high likelihood of being fraud, waste and/or abuse and, if so, the specialized computing device issues a dishonor message.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIGS. 1A, 1B, and 1C together are a flowchart displaying a process of execution of an embodiment of the invention.

FIG. 2 is a chart displaying a utilization of different methods of data analysis in generating of event sequences, in an embodiment of the invention.

FIG. 3 is a chart displaying related event sequences classified as bi-directional, one directional, and rare, in an embodiment of the invention.

FIG. 4 is a diagram displaying event codes representing related events followed by event codes representing particular events, in an embodiment of the invention.

FIG. 5 is a diagram displaying event codes representing related events followed by event codes representing particular events and corresponding directional ratios, in an embodiment of the invention.

FIGS. 6A and 6B together are a block diagram showing a process of execution, including results of performance of intermediate steps, in an embodiment of the invention.

### DETAILED DESCRIPTION

Describing now in further detail these exemplary embodiments with reference to the figures as described above, the system, method, and apparatus for the Segment Temporal Analysis Used in Fraud, Waste, and Abuse Detection is described below. It should be noted that the drawings are not to scale.

A “specialized computing device,” as discussed in the context of this patent application and related patent applications, refers to one or multiple computer processors acting together, a logic device or devices, an embedded system or systems, or any other device or devices allowing for programming and decision making. Multiple computer systems with associated specialized computing devices may also be networked together in a local-area network or via the internet to perform the same function, and are therefore also a “specialized computing device” for the reasons discussed herein. In one embodiment, a specialized computing device may be multiple processors or circuitry performing discrete tasks in communication with each other. The system, method, and apparatus described herein are implemented in various embodiments as, to execute on a “specialized computing device[s],” or, as is commonly known in the art, a computing device specially programmed in order to perform a task at hand. A specialized computing device is a necessary element to process the large amount of data (i.e. thousands, tens of thousands, hundreds of thousands, or more of accounts and account histories). Furthermore, the present invention may take the form of a computer program product embodied in any tangible medium of expression having computer usable program code embodied in the medium. Computer program code for carrying out operations of the present invention may operate on any or all of the “specialized computing device,” or “a server,” “computing device,” “computer device,” or “system” discussed herein. Computer program code for carrying out operations of the present invention may be written in any combination of one or more programming languages, including an object-oriented programming language such as Java, Smalltalk, C++, or the like, conventional procedural programming languages, such as Visual Basic, “C,” “R,” Python, or similar programming languages. After-arising programming languages are contemplated as well.

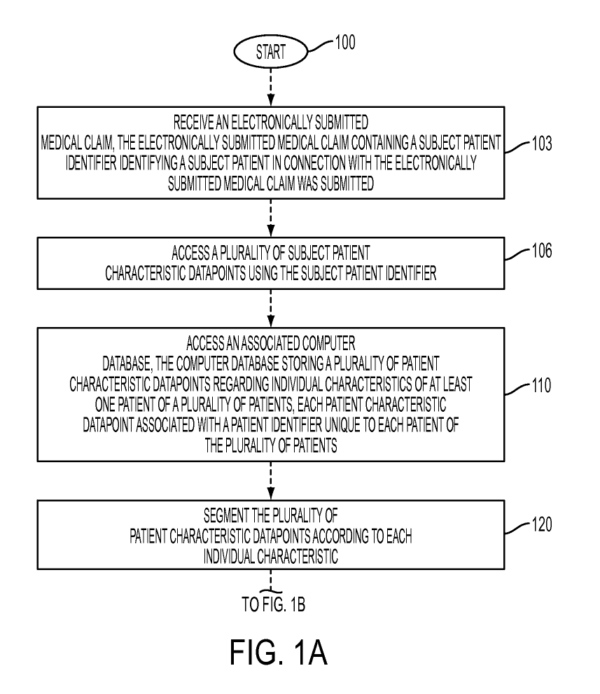

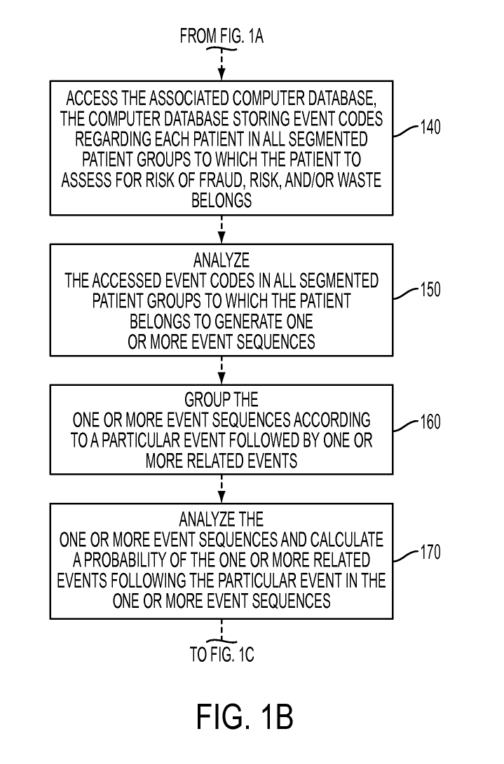

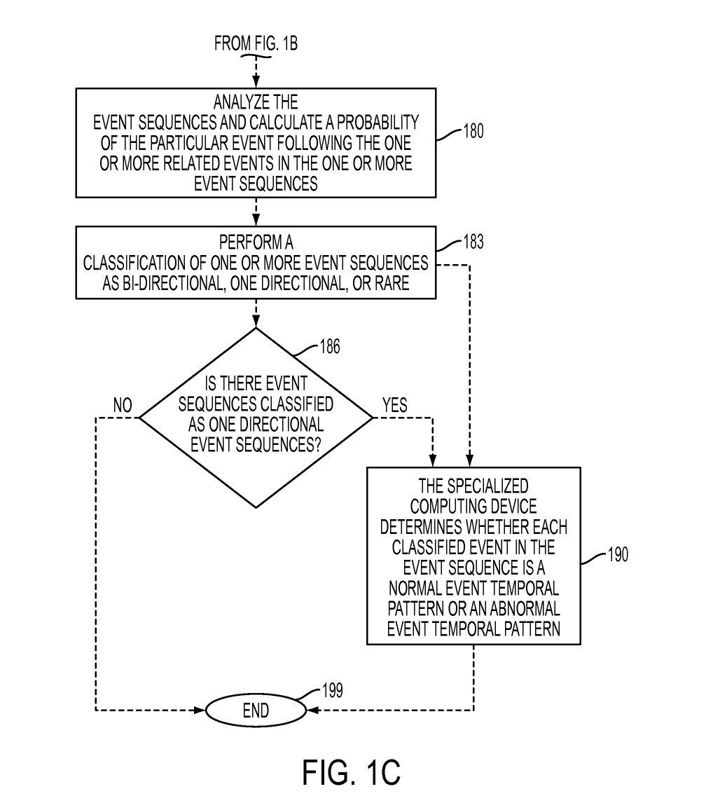

Referring to FIG. 1, displayed is a flowchart displaying a process of execution of an embodiment of the invention. Execution begins at “START,” step 100. At step 103, the specialized computing device receives an electronically submitted medical claim, the electronically submitted medical claim containing a subject patient identifier identifying a subject patient in connection with the electronically submitted medical claim was submitted. At step 106, the specialized computing device accesses a plurality of subject patient characteristic datapoints using the subject patient identifier. At step 110 the specialized computing device accesses an associated computer database, the computer database storing a plurality of patient characteristic datapoints regarding individual characteristics of at least one patient of a plurality of patients. In an embodiment of the invention, each patient characteristic datapoint is associated with a patient identifier unique to each patient (such as a social security number for the patient or a nine-digit, hyphenated number similar to a social security number) and confidential. In a further embodiment of the invention, the computer database is a claims database or an electronic medical record database. Each patient characteristic datapoint may track, for example, exactly one characteristic of individual characteristics (such as gender, height, weight, prior medical conditions, location, smoker (yes/no), use of alcoholic beverages (number per week), etc.) of the plurality of patients, as well as a patient social security number, dates of service, etc. At step 120, the specialized computing device segments the plurality of patient characteristic datapoints according to each individual characteristic. The individual characteristics utilized in segmentation include those discussed, as above, and any others.

At step 140, the specialized computing device again accesses the associated computer database, the computer database storing event codes regarding each patient in all segmented patient groups to which the patient to assess for risk of fraud, waste, and/or abuse belongs. The event codes may be diagnosis codes, procedure codes, diagnosis related group codes, or otherwise.

At step 150, the specialized computing device analyzes the event codes in all segmented patient groups to which the patient belongs using a data analysis method or methods to generate one or more event sequences. In various embodiments, the data analysis method(s) may be a neighboring-event sequence-seeking method, a starting-point fixed event sequence-seeking method, and a complete sequence seeking method. At step 160 the specialized computing device groups the one or more event sequences according to a particular event followed by one or more related events. At step 170 the specialized computing device analyzes the one or more event sequences and calculates a probability of the one or more related events following the particular event in the one or more event sequences. At step 180, the specialized computing device analyzes the event sequences by the specialized computing device and calculates a probability of the particular event following the one or more related events in the one or more event sequences. After event sequences of all segmented groups of patients have been studied, at step 183, the specialized computing device performs a classification of one or more event sequences as bi-directional, one directional, or rare. In an embodiment of the invention, the classification of one or more events as bi-directional, one directional, or rare is based on a calculated directional ratio. Execution may then proceed directly to step 190, or to step 186. At step 186, a determination is made whether there are event sequences classified as one directional event sequences. If no, execution terminates 199, or may restart from “START,” 100. If, on the other hand, at step 186 a determination is made that there are event sequences classified as one directional, execution proceeds to step 190. At step 190, where the specialized computing device determines whether each classified event in the event sequence is a normal event temporal pattern or an abnormal event temporal pattern. In the assessment of whether or not an event sequence is a normal event temporal pattern or an abnormal event temporal pattern, in an embodiment of the invention temporal analytics detect “outliers” (potential FWA cases) by comparing the event temporal sequences of each patient with the normal or abnormal event temporal patterns provided to the specialized computing device previously by subject matter experts or otherwise. In a further embodiment of the invention, the abnormal event temporal pattern is consistent with fraud, waste, and/or abuse, whereas the normal event pattern is not. Since the present invention offers the advantage of utilization of segmented patient characteristic datapoints according to each individual characteristic (as discussed previously), the results of step 190 are accurate since individual characteristics maintained by the plurality of patient characteristic datapoints are considered. Since common diseases are associated with and related to patient individual characteristics (such as, by means of non-limiting example, height, weight, gender, and location), the presently disclosed invention captures these differences with the use of segmented patient characteristic datapoints. In a further embodiment of the invention, after execution of the steps above but prior to end 199, the specialized computing device, based upon classified events in the event sequence classified as normal event temporal patterns or abnormal event temporal patterns, may determine the electronically submitted medical claim has a high likelihood of being fraud, waste, and/or abuse and, if so, issue a dishonor message.

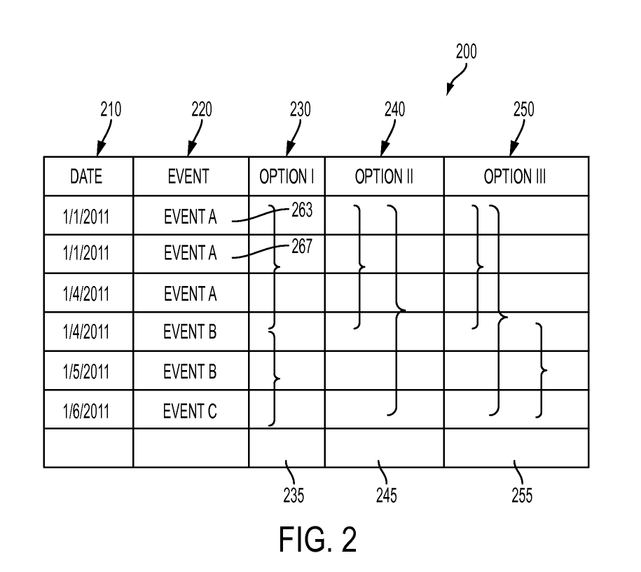

Referring to FIG. 2, displayed is a chart 200 displaying a utilization of different methods of data analysis 230, 240, 250 in generation of event sequences from analyzing of event codes, in an embodiment of the invention. The methods of data analysis 230, 240, and 250 are used by the specialized computing device to analyze event codes in segmented patient groups and generate the one or more event sequences. Displayed at column 210 is a date each event (or claim) occurred. Displayed at column 220 is a name of each event. For simplicity's sake, events (or claims) in column 220 are simply listed as “Event A,” “Event B,” or “Event C,” and these events/claims correspond with event codes, in an embodiment of the invention. Shown in column 230 are results of utilization of “Option I” 235, or results of use of a simple neighboring-event sequence-seeking method. Shown in column 240 is “Option II,” or results 245 of use of a starting-point fixed event sequence-seeking method. Shown in column 250 is “Option III” or results 255 of use of a complete sequence seeking method consisting of multiple seeking iterations of Option II 240 with changing starting points, as shown in Option I 230. Option III 250 may be utilized more frequently than Option I 230 and Option II 240, since in Option I 230 results 235 and Option II 240 results 245 are only proportional to the number of events 220, whereas in Option III more sequence results 255 are obtainable. Note that in a further embodiment, with utilization of any of data analysis methods 230, 240, and 250, if an event appears in a previous claim or event, (such as with Event A at 263 and 267), it is ignored when it is repeated.

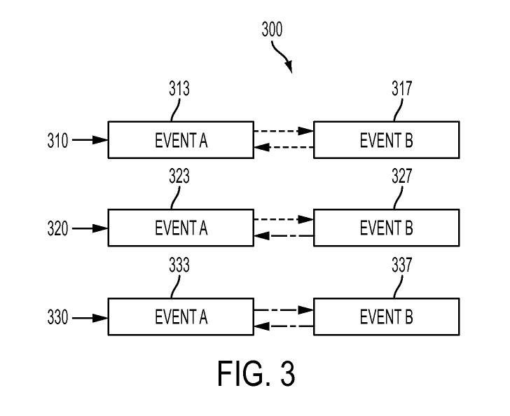

Referring to FIG. 3, displayed is a chart displaying event sequences classified as bi-directional, one directional, and rare. In an embodiment of the invention, the specialized computing device, after calculating a probability of a particular event following one or more related events in the one or more event sequences, classifies the event sequences as a bi-directional sequence 310, a one directional sequence 320, or a rare sequence 330. In a further embodiment, the classification of the event sequences as bi-directional, one directional, or rare occurs based upon a comparison by the specialized computing device with a reference directional ratio. In FIG. 3, events are listed as “Event A” or “Event B.” The bi-directional event sequence 310 indicates that Event A 313 leads to Event B 317, and Event B 317 leads also to Event A 313 with roughly equal probability, and it is thus “bi-directional.” The one directional event sequence 320 indicates that Event A 323 commonly leads to Event B 327 (a high probability), but there is no or hardly no event sequences found where Event B 327 leads to Event A 323. The rare event sequence 330 indicates there is rarely a connection between Event A 333 and Event B 337, and also rarely a connection between Event B 337 and Event A 333. In any classification of an event sequence, the reference directional ratio compared with calculated directional ratios may be used.

Knowledge of whether a sequence is “bi-directional,” “one directional,” or “rare,” as discussed elsewhere herein, is useful in determining whether an event pattern is a “normal event pattern,” or an “abnormal event pattern.” In a further embodiment of the invention, one directional sequences are particularly important in a determination of whether an event pattern is a “normal event pattern,” or an “abnormal event pattern.” In effect, if in an event pattern Event A 323 occurs, leading to Event B 327, the event pattern is normal (at least with regard to Event A 323 and Event B 327 in the event pattern). On the other hand, if in event pattern Event B 327 leads to Event A 323 in the event pattern, the specialized computing device determines the event pattern is an abnormal event pattern (which may be fraud, waste, and/or abuse).

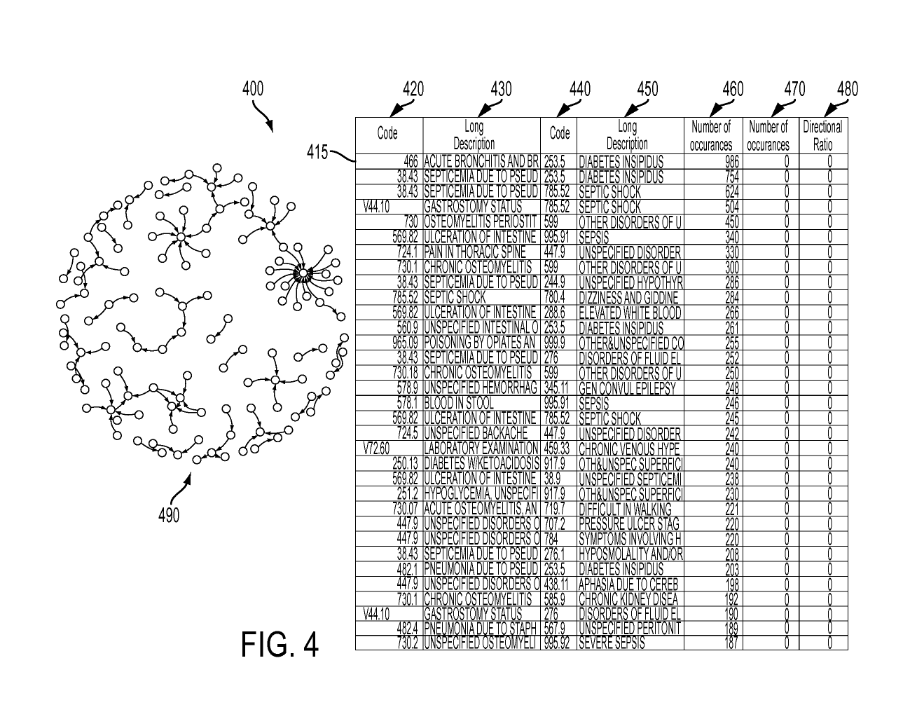

Referring to FIG. 4, displayed is a diagram 400 displaying event codes representing related events followed by event codes representing particular events, in an embodiment of the invention. Data such as provided in connection with FIG. 4 may be utilized by a specialized computing device to determine a probability of one particular event following one or more related events via calculation of a directional ratio, and therefore be used in a classification of whether one or more event sequences are bi-directional, one directional, or rare, in an embodiment of the invention. Displayed as with row 415 are event sequences. Displayed at column 420 are event codes, procedure codes, and/or diagnosis related group codes retrieved from a computer database by the specialized computing device, these codes corresponding with diagnoses made by a medical professional, billing for office visits, procedures performed or that should be performed, pharmaceuticals or medical device prescribed, rehabilitation scheduled, etc. The event codes/procedure codes/diagnosis related group codes shown in column 420 are derived from all treatments by all patients in the computer database, or all treatments by all patients in a segmented patient group to which a patient to assess for fraud, waste, and/or abuse belongs. The event codes/procedure codes/diagnosis related group codes displayed in column 420 may be considered for the sake of the present invention to be the “related event,” when determining a probability of a “particular event” following the “one related event” (as discussed herein). Displayed at column 430 are long descriptions associated with each event code/procedure code/diagnosis related group code in column 420. Displayed at column 440 are event codes/procedure codes/diagnosis related group codes representing the following particular events, as well as their long descriptions 450. At column 460, a number of occurrences where the particular event (in column 440) follows the related event (in column 420) are also displayed. The number of occurrences where the related event (in column 420) follows the particular event (in column 440) has not been recorded at column 470, and neither has a directional ratio been calculated yet at column 480. At 490, a visual representation of determined event sequences (specifically, of particular events follow related events) is displayed.

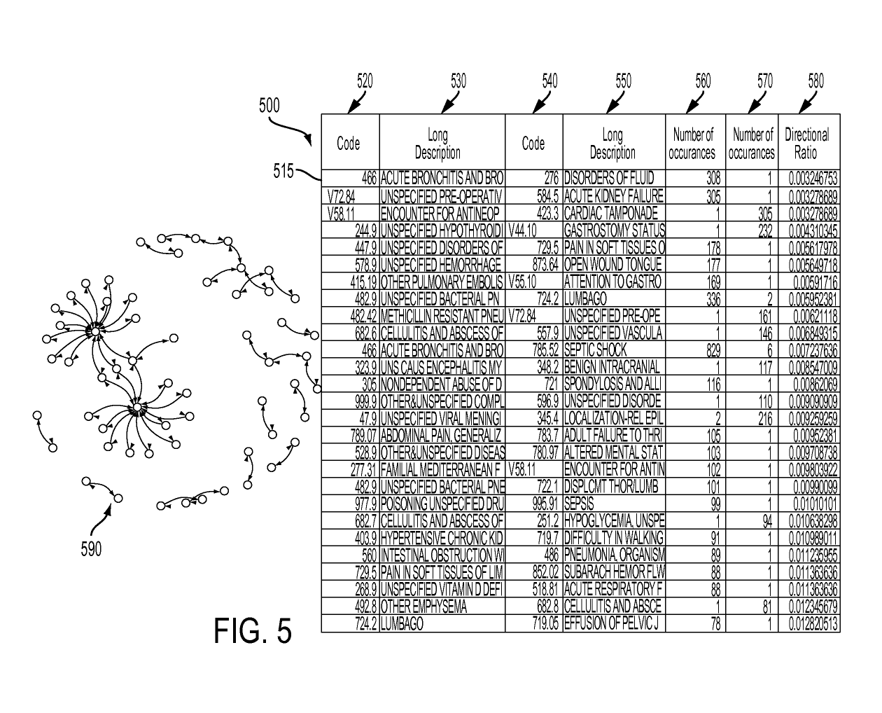

Referring to FIG. 5 is a diagram 500 displaying event codes representing related events followed by event codes representing another particular event and corresponding directional ratios, in an embodiment of the invention. Data such as provided in connection with FIG. 5 may be utilized by a specialized computing device to determine a probability of a particular event following one or more related events, or determine a probability of one or more related events following the particular event, via utilization of two calculated directional ratios, one calculated for each direction. The two calculated directional ratios may be used in a classification of event sequences as bi-directional, one directional, or rare in an embodiment of the invention. Displayed as with row 515 are event sequences. Displayed at column 520 are event codes, procedure codes, and/or diagnosis related group codes retrieved from a computer database by the specialized computing device. The event codes/procedure codes/diagnosis related group codes displayed in column 520 may be considered for the sake of the present invention to be the “related event,” when determining a probability of a “particular event” following the “one or more related events” (as discussed herein). Displayed at column 530 are long descriptions associated with each event code/procedure code/diagnosis related group code shown in column 520. Displayed at column 540 are event codes/procedure codes/diagnosis related group codes representing the particular following events, as well as their long descriptions 550. At column 560, a number of occurrences where the particular event (in column 540) follows the related event (in column 520) are also displayed. In FIG. 5, at column 570 a number of occurrences where the related event (in column 520) follows the particular event (in column 540) is recorded. A directional ratio has been calculated at column 580. In an embodiment of the invention, the specialized computing device may utilize the calculated directional ratio (column 580) (and/or another calculated directional ratio calculated in another direction (not shown here) in a determination of whether each event sequence (e.g. 515) is bi-directional, one directional, or rare). In such circumstances, the calculated directional ratio(s) may be compared to reference directional ratio to determine whether an event sequence is bi-directional, one directional, or rare. At 590, a visual representation of determined event sequences is displayed.

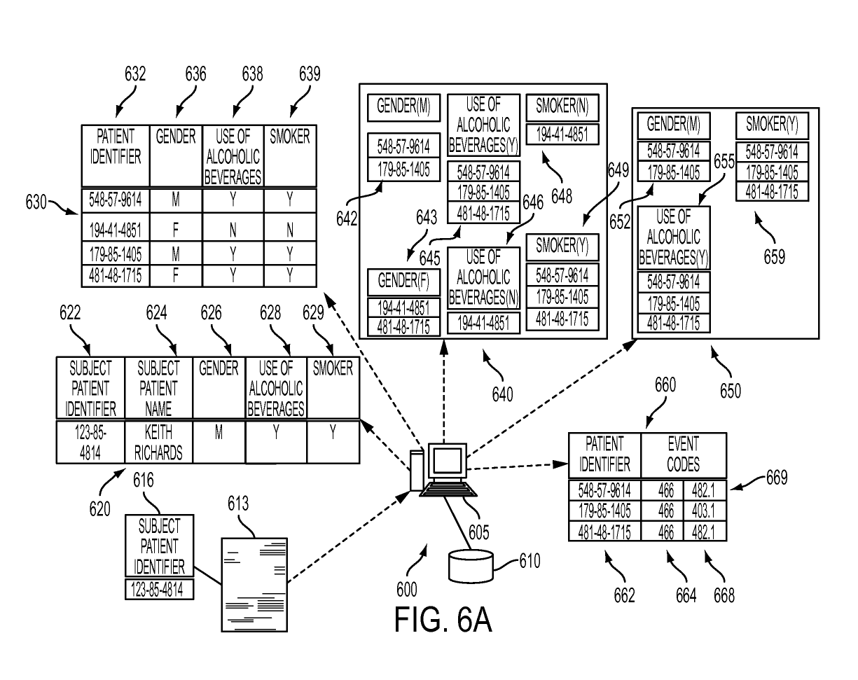

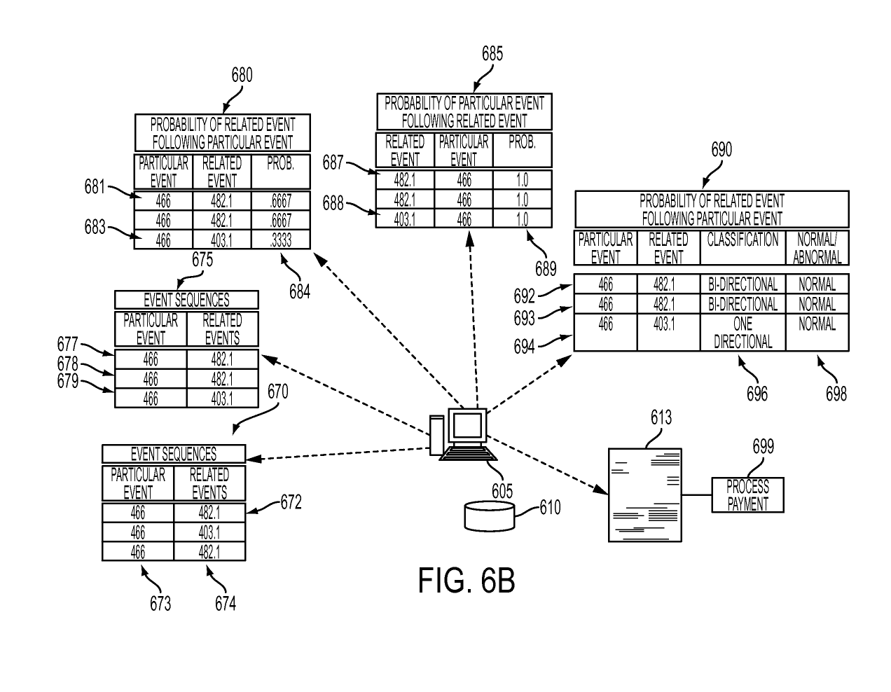

Referring to FIG. 6A, displayed is a block diagram 600 showing a process of execution, including results of intermediate steps, in an embodiment of the invention. A specialized computing device 605 associated with a computer database 610 is displayed as a center of processing. The computer database 610 may consist of a single computer storage unit, or multiple ones in association with each other and/or the specialized computing device 605, each computer storage unit holding unique data. Alternately, at each step requiring data access (as described below) a separate computer database having data relevant to the step (not shown here) is accessed, thus maximizing the confidentiality of data. Execution begins with the specialized computing device 605 receiving an electronically submitted medical claim 613, submitted for payment. The electronically submitted medical claim 613 contains a subject patient identifier 616 identifying a subject patient in connection with the electronically submitted medical claim was submitted. The electronically submitted medical claim 613 also contains two or more subject patient event codes, the event codes may be diagnosis codes, procedure codes, diagnosis related group codes, or otherwise regarding the subject patient. The event codes each indicate a diagnosis, procedure, medicine prescribed, treatment, or other service provided to the subject patient by a medical professional, medical supply company, or any other individual engaged in the health care industry. The specialized computing device 605 accesses and utilizes the subject patient identifier 616 to access a plurality of subject patient characteristic datapoints associated with the subject patient, displayed at step 620. The subject patient characteristic datapoints 620 (and other datapoints, codes, etc.) as described in further steps herein may be understood to be stored, at least temporarily, in memory, a data structure, a linked list, a variable, an object, registers, secondary storage, or any other computer-implemented unit of data storage and/or manipulation. The plurality of subject patient characteristics may include the subject patient identifier 622 accessed 616, the subject patient's name 624 (“Keith Richards”), the gender of the subject patient 626 (“M[,]” indicating male), whether the subject patient uses alcoholic beverages (628) (“Y” indicating yes), and whether the subject patient is a smoker (629) (“Y” indicating yes). The specialized computing device 605 then accesses a computer database 610, the computer database 610 storing a plurality of patient characteristic datapoints 630 regarding individual characteristics of a plurality of patients. Each individual patient characteristic datapoint 636-639 is associated with a patient identifier 632 unique to each patient of the plurality of patients. Note, each patient identifier 632 may be confidential, and not specifically associated with names of the patients (in the interests of maintaining data anonymity). Displayed are nine digit numbers, but any unique identifier of letters, numbers, or combination thereof may be utilized 632. The patient characteristic datapoints 630 as further discussed herein are used as a background against which the specialized computing device 605 processes. The specialized computing device 605 utilizes the patient characteristic datapoints 630 to segment the plurality of patient characteristic datapoints into segmented patient groups 640, according to each individual characteristic 642-649. Displayed within the segmented patient groups 640 are segmented patient groups of all patient identifiers that are associated with male patients 642 and all that are female 643. Displayed are also segmented patient groups of all patient identifiers associated with patients who drink alcoholic beverages 645, and those that do not drink alcoholic beverages 646. Finally, displayed are segmented patient groups of all patient identifiers of non-smokers 648, and all patient identifiers of smokers 649. In practice, at steps 630 and 640 the specialized computing device 605 has access to a much greater number of patient characteristic datapoints, associated with more patients, for calculation of the most accurate results possible. Steps 630, 640, 650, et seq. are displayed as shown with a minimum of patient characteristic datapoints in FIGS. 6A and 6B for the sake of simplicity and aiding the reader in understanding of the presently disclosed invention. A computing device of some sort is a necessary element to process this amount of data in a reasonable time. Next, the specialized computing device 605 determines which segmented patient groups 640 the subject patient is associated with. The specialized computing device 605 previously at step 620 accessed the plurality of subject patient characteristic datapoints 620, noting the subject patient is a male (626), uses alcoholic beverages (628), and smokes (629). The specialized computing device 605 then examines the segmented patient groups 640 and retrieves the segmented patient groups 642-649 expressing the same subject patient characteristic datapoints as the subject patient. The resulting segmented patient groups 652, 655, 659 to which the subject patient shares characteristics are displayed 650. Thus, a segmented patient group consisting of all patient identifiers associated with patients who are male is displayed 652, a segmented patient group consisting of all patient identifiers associated with patients who use alcoholic beverages is displayed 655, and a segmented patient group consisting of all patient identifiers associated with patients who are smokers is displayed 659. In this embodiment, when the specialized computing device 605 retrieves segmented patient groups 642-649, it is retrieving segmented patient groups where the patient displays a single individual characteristic held in common with the subject patient. In alternate embodiments, the presently disclosed invention may retrieve only segmented patient groups of individuals where the individuals share more than one or all individual characteristics with the subject patient (here, for example, all patients who are male, smokers, and use alcoholic beverages). As execution proceeds, the specialized computing device 605 then accesses the computer database 610, the computer database 610 storing event codes regarding each patient in all segmented patient groups to which the subject patient belongs (displayed 660). All such patient identifiers are displayed 662, along with event codes 664 and 668. In alternate embodiments of the invention, a separate database may be utilized at step 660, which may be a claims database or an electronic medical record database. Row 669 displays a summary of such data for patient 548-57-9614.

Execution proceeds in FIG. 6B. The specialized computing device 605 then analyzes the accessed event codes 664, 668 in all segmented patient groups to which the subject patient belongs and uses a data analysis method to generate one or more event sequences, as displayed at step 670. Each event sequence (e.g. 672) comprises a particular event (shown in column 673) followed by one or more related events (showing in column 674). For the sake of ease of understanding and simplicity, only a small number of particular events 673 and related events 674 are displayed. In practice, the presently disclosed invention may have a large number of particular events and related events for processing. The specialized computing device 605 at step 675 then groups the one or more event sequences according to a particular event followed by one or more related events. Step 675 shows three event sequences 677, 678, 679. At 677 and 678 two occurrences are noted of the particular event indicated by event code 466 followed by related event indicated by event code 482.1. At 679 one occurrence is noted of particular event 466 followed by related event 403.1.

At step 680, the specialized computing device 605 then analyzes the one or more event sequences 677, 678, 679 and calculates a probability of the one or more related events following the particular event in the one or more event sequences. Such event sequences are displayed 681, 683. The calculated probabilities of the one or more related events following the particular event in the one or more event sequences are also displayed at column 684. At step 685, the specialized computing device 605 then again analyzes the one or more event sequences 677, 678, 679, this time in a reverse direction, and calculates a probability of the particular event following the one or more related events in the one or more event sequences. Such reversed event sequences are displayed 687, 688. The calculated probabilities of the particular event following the one or more related events are displayed at column 689.

In an embodiment of the invention, after step 685 at step 690 the specialized computing device 605 may utilize the calculated probabilities of the one or more related events following the particular event 684 as well as the calculated probabilities of the particular event following the one or more related events displayed 689 to classify each event sequence (e.g. 692, 693, 694) as bi-directional, one directional, or rare 696. In order to classify each event sequence 692, 693, 694, the specialized computing device 605 may calculate a quotient of the calculated probabilities of the one or more related events following the particular event 684 divided by the calculated probabilities of the same particular event following the same one or more related events 689, and compare the calculated result to a reference directional ratio. Any number between 0.00 and 1.00 may be utilized as a reference directional ratio, however 0.5 may be a common choice. Based upon the classification of event sequences 696, the specialized computing device 605 may further classify the event sequences (e.g. 692, 693, 694) as “normal” event temporal patterns or “abnormal” event temporal patterns 698.

Finally, based on classifications of event sequences 692, 693, 694 as normal or abnormal 698, the specialized computing device 605 determines whether the electronically submitted medical claim 613 is to be paid. Here at step 690, the specialized computing device 605 decided all event sequences 692, 693, 694 were normal 698. In an embodiment, when determining whether to pay the medical claim 613, the specialized computing device 605 compares the subject patient event codes originally submitted in the electronically submitted medical claim 613 with the event sequences 692, and determines whether the subject patient event codes resemble more closely the normal or abnormal event sequences 698. Since all of the event sequences 698 considered as background were classified as normal, the specialized computing device 605 determines to approve the medical claim 613 and process payment 699. On the other hand, if the electronically submitted medical claim has a high likelihood of being fraud, waste, and/or abuse, the specialized computing device 605 issues a dishonor message. As discussed elsewhere herein, in further embodiments of the invention the specialized computing device 605 determines whether to process payment 699 or not based solely upon based upon event sequences classified as one directional event sequences (e.g. 694).

The preceding description has been presented only to illustrate and describe the invention. It is not intended to be exhaustive or to limit the invention to any precise form disclosed. Many modifications and variations are possible in light of the above teachings.

As will be appreciated by one of skill in the art, the presently disclosed invention is intended to comply with all relevant local, city, state, federal, and international laws and rules.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

What is claimed is:

1. A method of utilizing a specialized computing device to determine whether an electronically submitted medical claim submitted for payment has a high likelihood of being fraud, waste, and/or abuse in medical billing via utilization of a segmented temporal analysis by the specialized computing device of electronic medical record history of a plurality of patients, said method comprising:
Receiving by the specialized computing device the electronically submitted medical claim, the electronically submitted medical claim containing a subject patient identifier identifying a subject patient in connection with the electronically submitted medical claim was submitted;
Accessing by the specialized computing device using the subject patient identifier a plurality of subject patient characteristic datapoints;
Accessing a computer database associated with the specialized computing device, the computer database storing a plurality of patient characteristic datapoints regarding individual characteristics of the plurality of patients, each patient characteristic datapoint associated with a patient identifier unique to each patient of the plurality of patients;
Segmenting the plurality of patient characteristic datapoints into segmented patient groups according to each individual characteristic;
Accessing the computer database associated with the specialized computing device, the computer database storing event codes regarding each patient in all segmented patient groups to which the subject patient belongs;
Analyzing by the specialized computing device of the accessed event codes in all segmented patient groups to which the subject patient belongs to generate one or more event sequences;
Grouping by the specialized computing device the one or more event sequences according to a particular event followed by one or more related events;
Analyzing the one or more event sequences by the specialized computing device and calculating a probability of the one or more related events following the particular event in the one or more event sequences; and
Analyzing the event sequences by the specialized computing device and calculating a probability of the particular event following the one or more related events in the one or more event sequences.

2. The method of claim 1, wherein after calculating by the specialized computing device the probability of the particular event following the one or more related events in the one or more event sequences, the specialized computing device classifies the one or more event sequences as bi-directional, one directional, or rare.

3. The method of claim 2, wherein the specialized computing device performs the classification of the one or more event sequences as bi-directional, one directional, or rare, the classification based upon a calculated directional ratio.

4. The method of claim 3, wherein based upon the classification of the event sequences, the specialized computing device determines whether each classified event in the event sequence is a normal event temporal pattern or an abnormal event temporal pattern.

5. The method of claim 3, wherein based upon event sequences classified as one directional event sequences, the specialized computing device determines whether each classified event in the event sequence is a normal event temporal pattern or an abnormal event temporal pattern.

6. The method of claim 4, wherein based upon classified events in the event sequence classified as normal event temporal patterns and abnormal event temporal patterns, the specialized computing device determines whether the electronically submitted medical claim has a high likelihood of being fraud, waste, and/or abuse and, if so, the specialized computing device issues a dishonor message.

7. The method of claim 5, wherein based upon classified events in the event sequence classified as normal event temporal patterns and abnormal event temporal patterns, the specialized computing device determines whether the electronically submitted medical claim has a high likelihood of being fraud, waste, and/or abuse and, if so, the specialized computing device issues a dishonor message.

8. The method of claim 1, wherein the computer database is a claims database or an electronic medical record database.

9. The method of claim 1, wherein when generating the one or more event sequences, the specialized computing device analyzes the accessed event codes using one or more of the following: a neighboring-event sequence-seeking method, a starting-point fixed event sequence-seeking method, and a complete sequence seeking method.

10. The method of claim 1, wherein the patient individual characteristics comprise one or more of the following: age of patient, gender of patient, and location of patient.

11. The method of claim 1, wherein the subject patient identifier and patient identifier unique to each patient are confidential identification numbers.

12. The method of claim 10, wherein the location of the patient is maintained by selectively one of the following: town, municipality, zip code, state, and county.

13. A system utilizing a specialized computing device to determine whether an electronically submitted medical claim submitted for payment has a high likelihood of being fraud, waste, and/or abuse in medical billing via utilization of a segmented temporal analysis by the specialized computing device of electronic medical record history of a plurality of patients, said system comprising steps of:
The specialized computing device receives the electronically submitted medical claim, the electronically submitted medical claim containing a subject patient identifier identifying a subject patient in connection with the electronically submitted medical claim was submitted;
The specialized computing device accesses a plurality of subject patient characteristic datapoints using the subject patient identifier;
The specialized computing device accesses a computer database associated with the specialized computing device, the computer database storing a plurality of patient characteristic datapoints regarding individual characteristics of the plurality of patients, each patient characteristic datapoint associated with a patient identifier unique to each patient of the plurality of patients;
The plurality of patient characteristic datapoints are segmented into segmented patient groups according to each individual characteristic;
The computer database associated with the specialized computing device is accessed, the computer database storing event codes regarding each patient in all segmented patient groups to which the subject patient belongs;
The specialized computing device analyzes the accessed event codes in all segmented patient groups to which the subject patient belongs to generate one or more event sequences;
The specialized computing device groups the one or more event sequences according to a particular event followed by one or more related events;
The specialized computing device analyzes the one or more event sequences by the specialized computing device and calculates a probability of the one or more related events following the particular event in the one or more event sequences; and
The specialized computing device analyzes the event sequences and calculates a probability of the particular event following the one or more related events in the one or more event sequences.

14. The system of claim 13, wherein after the specialized computing device calculates the probability of the particular event following the one or more related events in the one or more event sequences, the specialized computing device classifies the one or more event sequences as bi-directional, one directional, or rare.

15. The system of claim 14, wherein the specialized computing device performs the classification of the one or more event sequences as bi-directional, one directional, or rare, the classification based upon a calculated directional ratio.

16. The system of claim 15, wherein based upon the classification of the event sequences, the specialized computing device determines whether each classified event in the event sequence is a normal event temporal pattern or an abnormal event temporal pattern.

17. The system of claim 15, wherein based upon event sequences classified as one directional event sequences, the specialized computing device determines whether each classified event in the event sequence is a normal event temporal pattern or an abnormal event temporal pattern.

18. The system of claim 16, wherein based upon classified events in the event sequence classified as normal event temporal patterns and abnormal event temporal patterns, the specialized computing device determines whether the electronically submitted medical claim has a high likelihood of being fraud, waste, and/or abuse and, if so, the specialized computing device issues a dishonor message.

19. The system of claim 17, wherein based upon classified events in the event sequence classified as normal event temporal patterns and abnormal event temporal patterns, the specialized computing device determines whether the electronically submitted medical claim has a high likelihood of being fraud, waste, and/or abuse and, if so, the specialized computing device issues a dishonor message.

20. The system of claim 13, wherein the computer database is a claims database or an electronic medical record database.

21. The system of claim 13, wherein when generating the one or more event sequences, the specialized computing device analyzes the accessed event codes using one or more of the following: a neighboring-event sequence-seeking method, a starting-point fixed event sequence-seeking method, and a complete sequence seeking method.

22. The system of claim 13, wherein the patient individual characteristics comprise one or more of the following: age of patient, gender of patient, and location of patient.

23. The system of claim 13, wherein the subject patient identifier and patient identifier unique to each patient are confidential identification numbers.
